(19) United States
(12) Patent Application Publication
(10) Pub. No.: US 2002/0088926 A1
(43) Pub. Date: Jul. 11, 2002

(54) Diagnostic imaging simulator

(76) Inventor: Stephen Daniel Prasser, Queensland (AU)

Correspondence Address: The Webb Law Firm, 700 Koppers Building, Pittsburgh, PA, 15219, US

(21) Appl. No.: 09/993,182

(22) Filed: Nov. 14, 2001

(30) Foreign Application Priority Data
Nov. 14, 2000 (AU) 728749

(51) Int. Cl. G06M 7/00; H01J 40/14

(52) U.S. Cl. 250/221

(57) ABSTRACT

A diagnostic imaging simulator is disclosed that includes a three-beam emitting mobile hand piece. The-mobile hand piece is moved around a reference surface that mimics an anatomical region of a patient. A detector identifies the position of the three beams on the surface and a location determining device determines the location of the mobile hand piece from those positions. A display then displays an image associated with the location of the mobile hand piece, which is preferably an image corresponding to that provided by a real imaging machine in a similar position.

### FIELD OF THE INVENTION

THIS INVENTION relates to a method and apparatus for simulating diagnostic imaging procedures and, in particular, for simulating the application of ultrasonography, especially echocardiography.

### BACKGROUND ART

Diagnostic imaging machines, techniques and procedures are an important and growing facet of applied medical technology. One of the most widely used applications involves the use of high frequency audio signals (“ultrasound”) for the purpose of diagnostic imaging. Ultrasonography is a specialised field requiring specialised training.

A sub-branch of this field is the use of ultrasound in echocardiography for generating images of the heart. By skilled manipulation of an ultrasound probe, a trained echocardiographer may observe and analyse position and efficiency of primary cardiac structures and functions, such as the ventricles, papillary muscles, discharge into the aorta and contractile movement of cardiac musculature.

The machines used in diagnostic imaging are almost universally expensive. Because of this expense and also because of the diagnostic advantages provided by such machines, their application is typically restricted to actual diagnostic procedures performed on patients. This creates a considerable problem in relation to training new technicians in the use of such machines. While such a trainee may accompany an experienced practitioner and receive considerable tuition, there is no substitute for hands on practice and experience with the machine itself. Each experienced sonographer can only supervise a maximum of two or three full time trainees. Given the risk to a patient and allied risk of litigation in the event a diagnostic procedure is not performed to a required standard, the opportunities for such trainees to receive substantial experience on actual working devices are restricted.

There would be an advantage in having a simulator which accurately recreated the prevailing conditions during operation of such an apparatus so that a trainee could acquire extensive access in a simulated environment prior to entry into real clinical situations.

It would further be of advantage to develop a training device which would allow technicians to gain the gross motor skills required in manipulating a diagnostic probe to achieve and maintain a desired anatomical view of a structure under investigation.

### OBJECT OF THE INVENTION

It is an object of the present invention to provide a device to overcome or ameliorate at least one of the above-described problems.

### SUMMARY OF THE INVENTION

In one form, although it need not be the only or indeed the broadest form, the invention resides in a diagnostic imaging simulator comprising:

a mobile hand piece for emitting at least three spaced beams;

a reference surface;

a detector for detecting the positions of the at least three beams on the reference surface;

a location determining device for determining the location of the mobile hand piece relative to the reference surface using the incidence of the at least three beams on the reference surface; and

a display for displaying an image associated with the location of the mobile hand piece.

The diagnostic imaging simulator may further comprise at least two spaced beam sources. Suitably, the spaced beam sources are infra-red laser diodes.

Preferably, the spaced beam sources are orientated to produce divergent beams. Alternatively, the sources may be orientated to produce parallel beams. The beams may alternatively be convergent.

The mobile hand piece may comprise four spaced beam sources. One of the four spaced beam sources may be orientated to produce a central beam relative to the other beams.

The detector is preferably a charge-coupled device (“CCD”) camera.

The location determining device may comprise a processor in signal connection with the detector, the location determining device programmed to determine the location of the mobile hand piece, preferably by establishing position, rotation and angle of inclination of the mobile hand piece relative to the reference surface. The location determining device may be programmed to determine the location of the hand piece in two or three dimensions.

The simulator preferably further comprises a library of stored video images, each video image associated with a respective location of the mobile hand piece. The images are preferably three dimensional computer generated models.

The simulator may include a beam identifier for identifying each beam. The beam identifier may include a controller to control emission of the beams. The controller may include sequential activator for emitting the beams sequentially.

In another form, the invention resides in a method of simulating a diagnostic imaging apparatus including the steps of:

transmitting at least three spaced beams from individual sources on a mobile hand piece;

detecting the relative positions of the spaced beams on a reference surface spaced from at least two of the sources;

determining the location of the hand piece from the relative position of the three beams; and

displaying an image associated with the position of the hand piece.

The method may further include the step of transmitting a fourth beam.

The method may also include the step of identifying individual beams, which may further include the step of transmitting the beams sequentially.

In a further form, the invention may reside in a method of simulating a diagnostic imaging apparatus including the steps of:

placing a mobile hand piece on a model of an anatomical surface;

transmitting at least three laser beams from the mobile hand piece;

detecting the relative position of the three laser beams with a camera spaced from the model;

determining the location of the mobile hand piece from the relative position of the laser beams; and

displaying a video image of an anatomical structure associated with the position of the mobile hand piece.

### BRIEF DESCRIPTION OF THE DRAWINGS

FIG. 1 is a schematic representation of a diagnostic imaging simulator of the invention.

FIG. 2 is a schematic representation of an echocardiographic simulator of the present invention.

FIG. 3 is a top view of an arrangement of components of an echocardiographic simulator within a mannequin.

FIG. 4 is a block diagram of echocardiographic views.

FIG. 5 is a representation of the actual views of FIG. 4.

FIG. 6 is of a series of planar views for mapping the position of a hand piece of a simulator.

FIG. 7 is a mapping diagram incorporating arcs for positioning a hand piece of a simulator.

FIG. 8 is a flow chart of the function of a diagnostic imaging simulator.

FIG. 9 is an expanded flow chart of the operation of a diagnostic imaging simulator.

FIG. 10 is a flow chart of determination of probe position by a diagnostic imaging simulator.

FIG. 11 is an expanded flow chart of the operation of a diagnostic imaging simulator.

FIG. 12 is two views of a head for a simulator.

FIG. 13 is a schematic view of a probe, reference surface and camera.

FIG. 14 is a view of the reference surface with two incident beams.

### DETAILED DESCRIPTION OF THE DRAWINGS

In describing the simulator of the invention, reference will be made to echocardiography by way of example only. It is clear to a skilled addressee that the invention may be applied to other forms of diagnostic imaging.

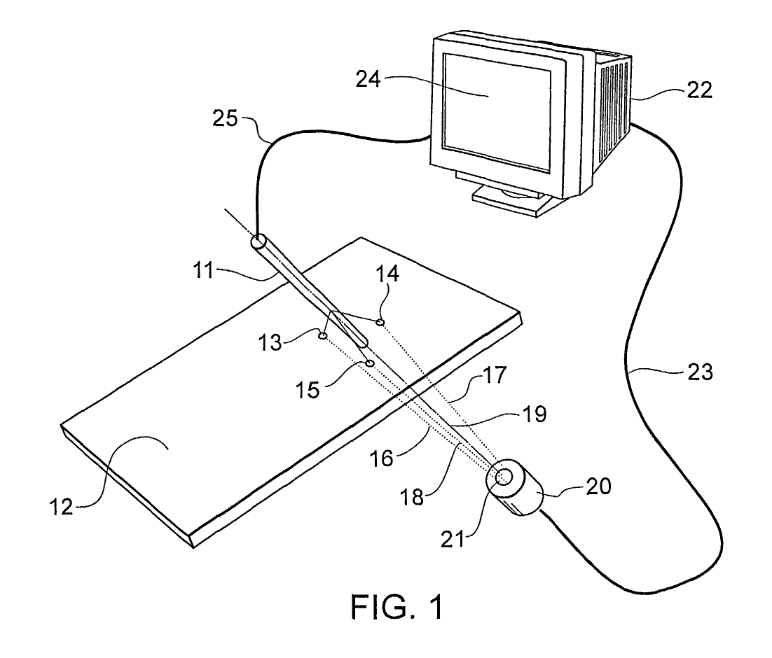

Referring to FIG. 1, there is shown hand piece or probe 11 located on reference surface 12. Hand piece 11 is a transducer having three emission sources, described in detail hereinafter, each of which gives rise to a beam 16, 17, 18, which are incident on the reference surface at points 13, 14, 15. The emission sources are located in positions removed from reference surface 12 when a contact region of probe 11 is in contact with the reference surface 12. In this view, the beams 16, 17, 18 are slightly convergent around a central longitudinal axis 19, although this is not essential. The beams may be parallel or preferably slightly divergent. When the beams 16, 17, 18 are directed towards surface 12, they form a triangle of dots which, in turn, are detected by a detector in the form of a charge-coupled device (“CCD”) camera 20. The surface 12 may be of a nature to permit passage of the beams so as to indicate the points of incidence when viewed from a side of the surface remote from the beam source, or at least indicate the point of incidence of the beams on the surface to CCD camera 20. The surface may be transparent to the beams so that the points of light formed on surface 12 are detectable by camera 20. A translucent surface is also acceptable if it allows adequate penetration of the beams for identification of their positions without significantly diffusing the points of incidence.

The relative positions of the beams 16, 17, 18 on the surface 12 are determined by a processor which may be computer 22 to which camera 20 is electrically connected by cable 23. Analysis of the information from camera lens 21 allows the computer 22 to determine the location of hand piece 11. This location is identified and a pre-recorded video image is identified and displayed on screen 24. The pre-recorded image is associated with the location of transducer 11 in that the image reasonably accurately represents a diagnostic image that would be shown if an actual diagnostic apparatus were being used on a patient and its transducer was in the identified location.

The image may be selected from a library of images, which have been mapped and matched to specific locations of transducer 11. The emission sources may be controlled by the computer 22 via cable 25. As a further refinement of the invention, the individual beams may be individually recognisable. This may be effected by a beam identifier, which causes sequential activation of the emission sources controlled by the computer.

Once individual beams are identifiable as well as their relative position, it is possible to map the location of the transducer in three dimensions and additionally map its rotation relative to central axis 19.

The use of a fourth beam directed along longitudinal axis 19 may further enhance the accuracy of the device when three beams are used. Direction of one beam along central longitudinal axis is of benefit in simplifying the analysis. In its simplest form, the simulator may have just one beam which would allow mapping of the position of a tip of the probe on the reference surface. This, however, would provide limited information.

The description in this specification is directed mainly to the diagnostic imaging associated with echocardiography, however, the invention is not specifically restricted to this form of diagnostic imaging. The invention may be applied to any imaging process that requires the use of a directional probe. This may include general ultra-sonography.

The emission sources are preferably laser diodes. A useful, commercially available form of diode is one that provides a wavelength of 780 nm at which wavelength the beam is infra-red and therefore the projection of the beam is invisible to the human eye. Additionally, a safety factor involved in this form of diode is that it has a 5 mW maximum optical power output, which is adequate for the positioning system but is not large enough to cause eye damage by direct exposure to the beam for short periods. The laser diodes may be suitably located on a dummy probe which imitates the probe of a functioning diagnostic device.

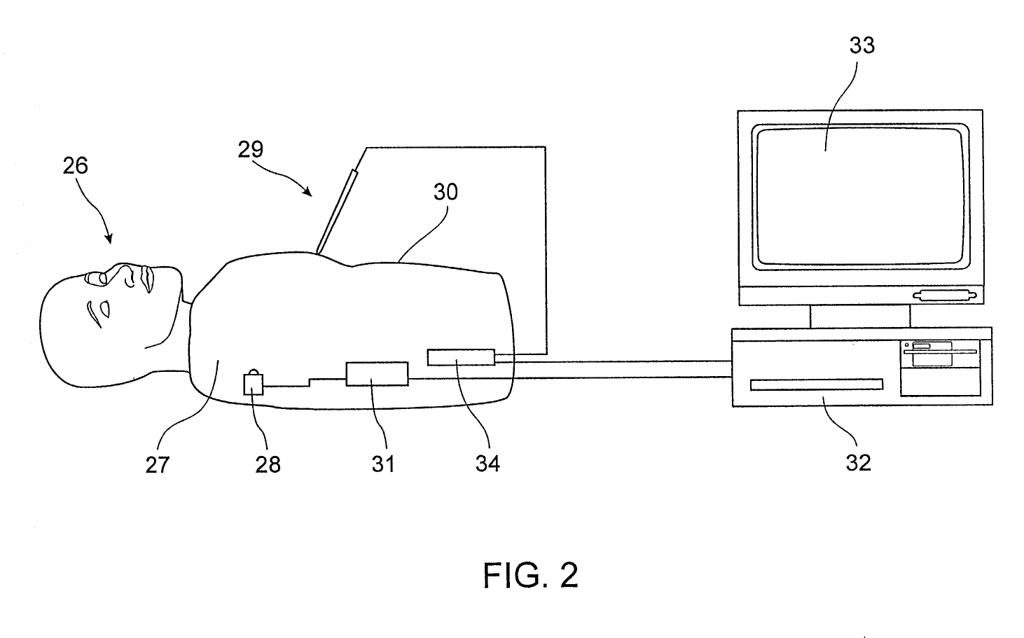

A mannequin 26 is shown in FIG. 2, wherein the mannequin is a model of a human thorax and head having internal space 27. A CCD camera 28 for detection of contact points on surface 30 of beams emitted from probe or hand piece 29 is sited in internal space 27. Probe 29 is supported on surface 30 which mimics the anterior chest wall of a person. The CCD camera 28 is electrically connected to a capture card 31 which, in turn, is connected via a port to computer 32. The computer 32 is programmed to process information received and determine the location of probe 29 on the surface 30 including rotation and orientation in three dimensions relative to the surface 30. A video capture card may be located inside the computer.

Once the location is identified, a video image associated with the location of the probe is displayed on screen 33. Associated means that the image replicates or is similar to an image that would be viewed if an actual echocardiographic machine was being used with a probe in the same location as probe 29 of the simulator. Computer 32 may be connected by its parallel port to laser diode driver circuits and power supply 34 which, in turn, is connected to probe 29 and controls the activation and sequencing of diode firing. This provides a means for identifying the beams as individual laser diode emissions may then be controlled and identified by processor 32 so that information received via the CCD camera 28 may be correlated with the information at hand in relation to diode firing.

Identification of individual beams allows an accurate determination of rotation and angulation of beams, probe 29.

In order to enable individual identification of the beams, they may be activated sequentially by application software. This may be achieved by sending control data to driver circuits via a port of the computer.

All hardware used to implement the positioning system, other than the lasers and computer, may be housed within the mannequin.

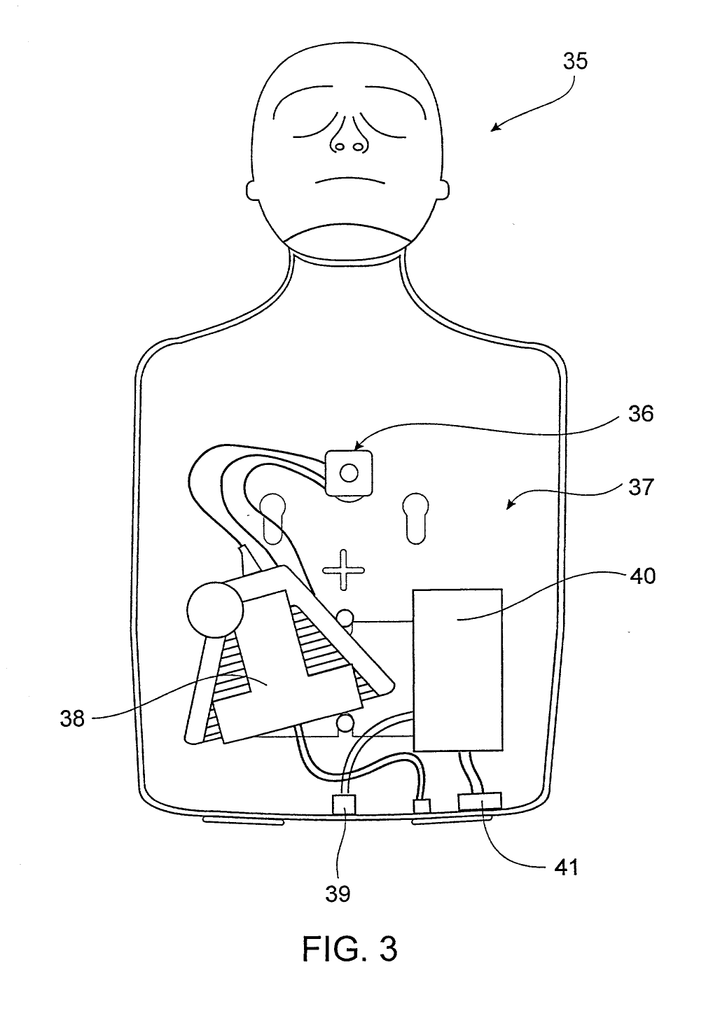

This arrangement is shown in FIG. 3. Mannequin 35 is shown with its anterior thorax component removed. CCD camera 36 is located on the rear chest wall 37. It is connected to a PCTV capture device 38 which, in turn, is connected to a plug 39 for receiving a cable connected to a computer. The laser diode drivers 40 may also be conveniently located within the thoracic cavity of the mannequin 35 again, in connection with a plug 41 for receiving a cable connection to a computer. A useful mannequin in the process of forming the training simulator is based on a standard Cardio-Pulmonary Resuscitation Training simulator. These are readily available. Such a device may require a shelter be constructed to act as support for its “skin”. The skin may be used as a mould into which clear casting resin is laid and which is reinforced with fibreglass matting. A window may then be cut into the resin and filled with a piece of clear acrylic which offers little resistance or dispersive effect to the passage of laser beams which will form dot points on the underside of the “skin” detectable by camera 36.

A simulator probe or hand piece should as far as possible duplicate the features of a real ultrasound probe. To enhance the learning experience for a user of the device, the laser diodes may be suitably mounted in a head component of the simulator probe and may be supported by epoxy resin. It is preferable that brass collimators be used with the laser diodes so as to focus the beams as well as to act as a heat sink. The collimators may also be mounted in the head of the simulator probe.

If one beam is central or aligned with the longitudinal axis of the hand piece, it is useful to have a minimum of three and preferably four beams with sources spaced from the reference surface with four beams, as the hand piece is inclined, one or two of the beams will move towards the central beam with decreasing increments with the arc of a distal end of the probe. However, at least one of the beam incident spots on the reference surface will move away from the central beam with increasing increments. In this increased spacing, the ability to accurately plot the hand piece position is increased.

The various ultrasound views that a cardiologist requires in a particular window may be achieved by manipulation of an ultrasound probe in three planes, being:

(i) rotation about its longitudinal axis;

(ii) inclination of the probe superiorly and inferiorly (i.e. up and down a line of the body of a patient); and

(iii) inclination laterally (i.e. across the line of the body of a patient).

In cardiac ultrasound, there are typically four windows used, being the parasternal, apical, subcostal and suprasternal windows. In this specification, reference will be made to the views of the parasternal window only. Clearly, the other windows may be used separately or accumulatively with the view discussed herein.

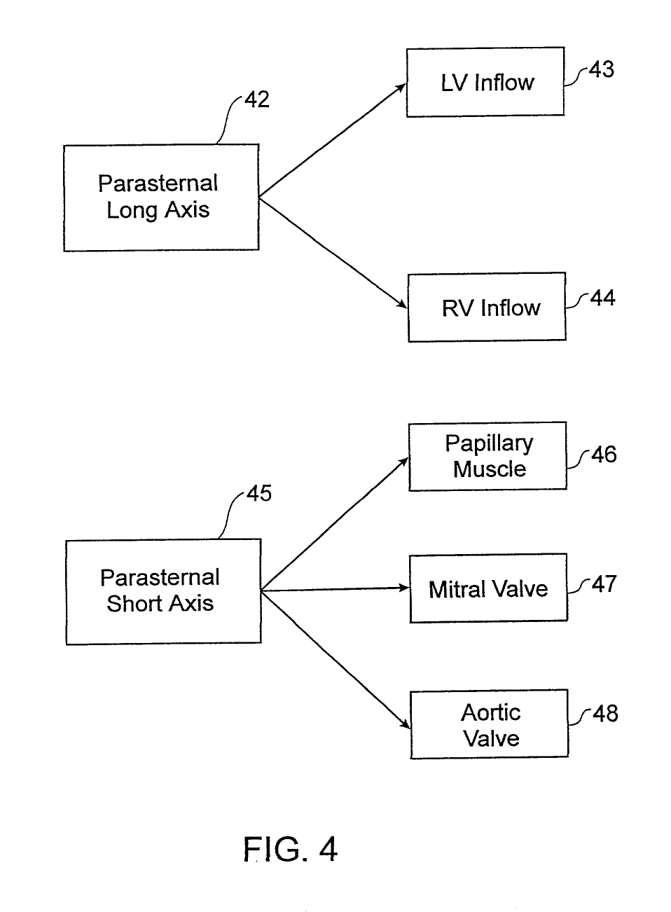

FIG. 4 shows the available views in the parasternal window and the features of anatomic or functional interest in those views. The first available view is the parasternal long axis 42, which is a view taken down the long axis of a patient's heart and which displays left ventricular inflow 43 and right ventricular inflow 44. The parasternal short axis 45 is a view taken across the heart. It demonstrates the functioning of the papillary muscle 46, mitral valve 47 and aortic valve 48.

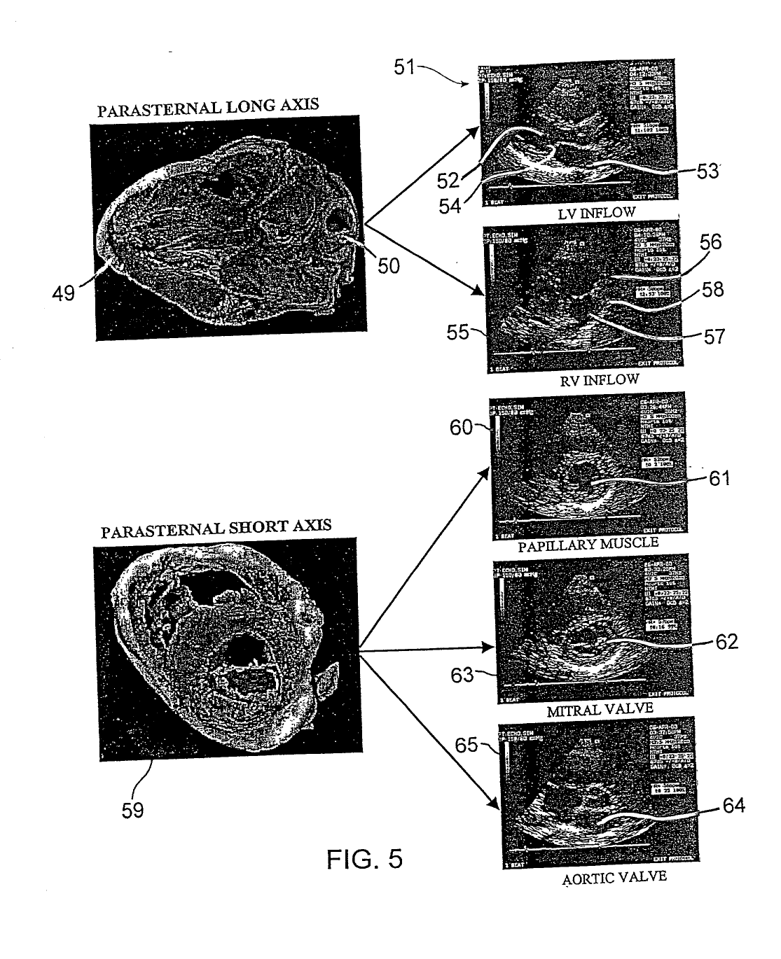

Referring to FIG. 5, there is shown a planar slice of the heart from apex 49 to base 50. This is a parasternal long axis view which may be highlighted by manipulation of an echocardiographic probe. It is possible to show left ventricular inflow as seen in 51 wherein the left ventricle is seen at 52, the left atrium at 53 and the atrioventricular valves at 54.

Right ventricular inflow is seen in the second ultrasound image 55, wherein the right ventricle 56, right atrium 57 and right atrioventricular valves 58 are visible. A transverse or parasternal short axis view of the heart is seen at 59. An associated ultrasound image produced by the appropriate manipulation of an ultrasound probe is seen at 60. This view highlights the papillary muscle 61.

The mitral valve 62 is seen in the image 63 and the aortic valve 64 is seen in image 65.

In practice, a single view may be used to highlight to a trainee that the probe position would produce an image as shown. That is, analysis of the position of the probe of the simulator is associated with an image such as shown in FIG. 5 which is substantially identical or similar to that which would be seen in a situation using a live patient and a real echocardiographic machine. Rather than still images, however, it is considered preferable to use video clips of functioning hearts. In relation to a particular probe position, a video clip may be taken from an actual diagnostic research or trial image in which both the probe and video image of the simulator correspond to the actual test and results. Clearly, in initial training it is preferable that non-symptomatic images be used. However, there is also an opportunity to train a user of such a device with examples of diseased organs which display pathologies or dysfunctional activities. The simulator may therefore be broadened in its application from training in normal function to diagnostic specialisation.

The inventor has found it useful to record one complete heartbeat at a particular position and then loop the recorded image of the cardiac cycle so that it gives a continuous beating image on the screen of the simulator.

In order to map the position of the probe it may be considered as a vector that also has a rotational movement. This allows any possible situation of the probe to be described by position, rotation, inclination inferiorly or superiorly and inclination laterally. This allows the creation of a three dimensional “map” of not only the desired locations but also of incorrect location from poor positioning which also may be incorporated into the simulator.

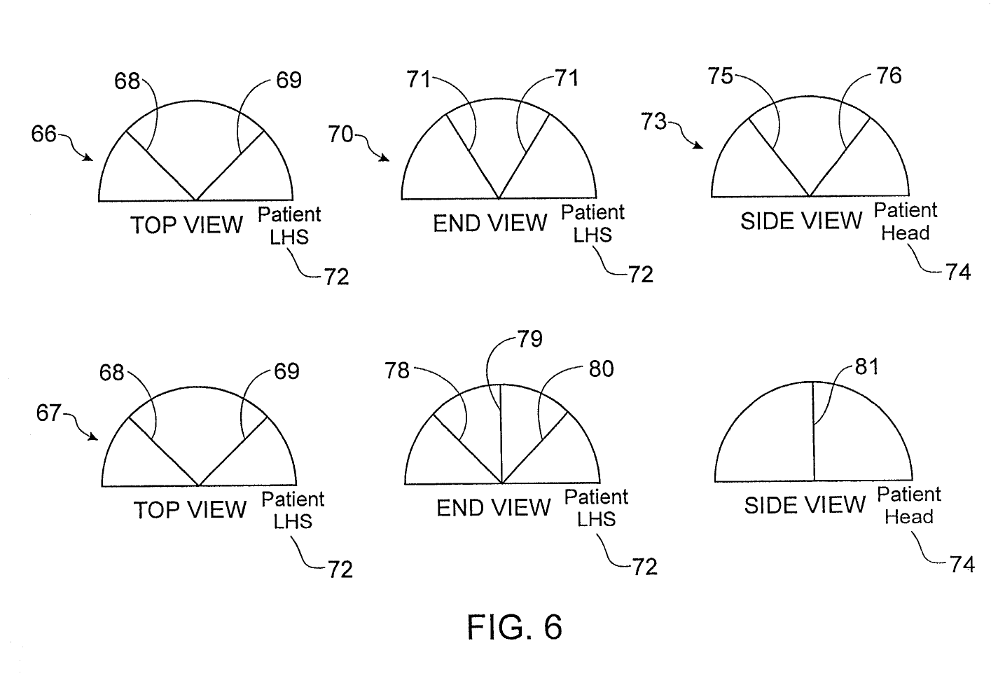

FIG. 6 shows maps for identifying the position of the probe in relation to the views of FIG. 5 when the probe tip is at a particular window or position on the chest. The desired position of the probe may be mapped and identified by representing the probe in each planar view, being the top view (which shows rotation), the end view (which shows lateral inclination) and the side view (which shows inferior and superior inclination). The views in FIG. 6 show the short axis and long axis views separated. The top view for both parasternal views is shown as the same 66, 67 with rotation of approximately 90° of the probe required to move from the parasternal long axis position 68 to the parasternal short axis position 69. The views on the top line show positions necessary for the long axis positions, namely in the end view 70, the right ventricular inflow position is seen at 71 when the patient's left-hand side is deemed to be located at 72. The left ventricular inflow position in side view 73 is obtained by moving the probe around an arc to the shown position. Simultaneously, the probe must be moved to left ventricular inflow position in side view when considered with a patient's head 74 to the right. The position for left ventricular inflow is shown at 75 and that for right ventricular inflow at 76.

The above positioning therefore gives a discreet and unique positioning for a particular location of the probe. Once that location is identified and duplicated in an ultrasound machine, the image displayed on screen while the probe is in that position may be recorded and the recorded image and the position of the probe associated in the simulator.

Parasternal short axis positions are shown in the second tier of FIG. 6. These positions are obtained by moving the probe to the parasternal short axis position 69 on the top view and then orientating it in end and side view positions as shown. In this view, the structures of interest are highlighted by lateral movement of the probe for the aortic valve position 78, mitral valve position 79 and papillary muscle position 80. No movement of the probe is required in a superior and inferior direction and the probe is held at approximately 90° to the patient's longitudinal axis as shown in upright position 81.

For example, the aortic valve may be located by rotating the probe to the parasternal short axis position, inclining the tail of the probe towards the patient's left-hand side and holding the probe at approximately 90° to the patient along the longitudinal axis of that patient. To move from the aortic to mitral valve view only requires moving the tail of the probe towards the patient's right-hand side with no change in inclination along the bodyline and no change in the rotation of the probe.

It is possible to rely strictly on the locations shown as being associated with a specific point alone. In reality, however, there is a small tolerance of movement in each plane which will still allow a correct view. In order to improve the performance of the simulator, it may be constructed to allow for this slight tolerance in the range of probe positions corresponding to a diagnostic image. In addition, it is also worthwhile to provide negative feedback for incorrect locations which may be obtained while trying to achieve the correct probe position. Negative feedback on the screen may be in the form of visual static or “noise”. Views which are significantly outside the parameter may show noise only. In situations closer to correct positioning of the probe, the simulator may show formed views that are obviously incorrect.

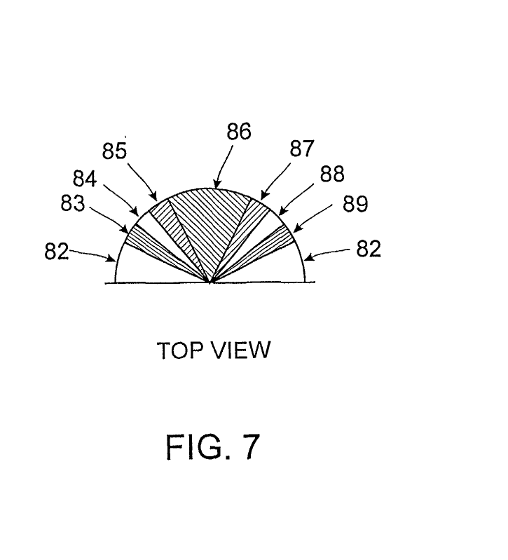

FIG. 7 shows the top view (seen as 66, 67 in FIG. 6) when arcs are allowed for the views (and errors) and those arcs are incorporated in a plane map. The 180° of position shown incorporates allowances for noise 82. An arc is shown for axis first error of the parasternal long axis in an anti-clockwise direction 83. An arc 84 of effective localisation of the probe to display the parasternal long axis is shown. An arc 85 is shown for parasternal long axis first error in a clockwise direction. A median error between long and short axis is represented by arc 86 and arc 87 for parasternal short axis first error in an anticlockwise direction is shown. An arc 88 for correct localisation of the probe for parasternal short axis views is shown. The first error in a clockwise direction for the parasternal short axis position is shown at 89. These arcs allow for a more effective and realistic imitation of the functioning of an actual ultrasound machine.

In applying software to the invention, it is preferable that the software provides the following capabilities:

(a) complete control over playback of pre-recorded ultrasound footage. Each cycle of a cardiac beat should be readily accessed at its beginning and any point throughout;

(b) control over the laser diodes so that sequential activation allows individual identification;

(c) the software should be able to demand still image captures from the capture card. As each laser is activated, the capture card should capture an image to record the position of the dot from that laser; and

(d) the still images from the capture hardware should be read directly from the frame buffer. Storing files to the hard drive is by and large too slow and processor intensive for the capture rates required.

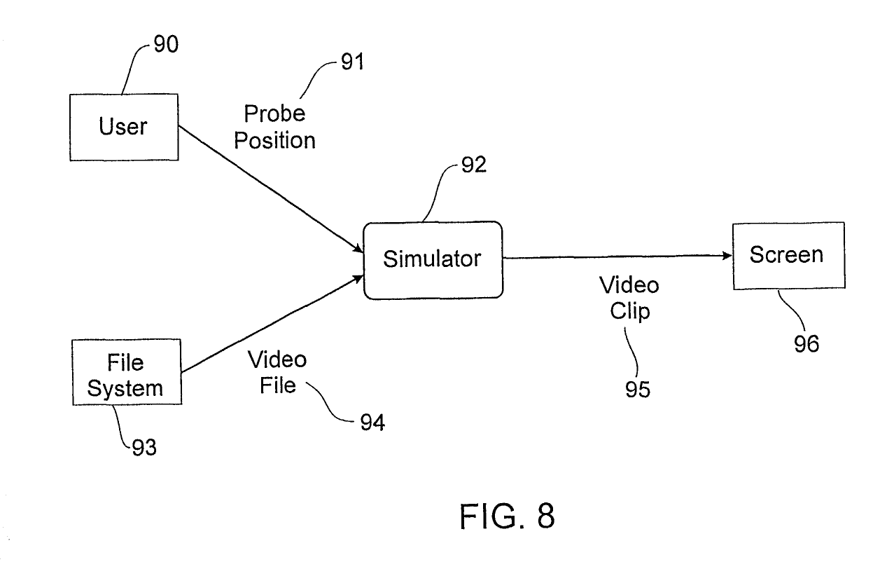

FIG. 8 is a context flow chart of dataflow for detailing the passage of data through the application. A user 90 positions a probe 91. The simulator 92 determines the locations of the probe, accesses file system 93, selects a video file 94 which is identified as associated with the probe location and displays video clip 95 on screen 96.

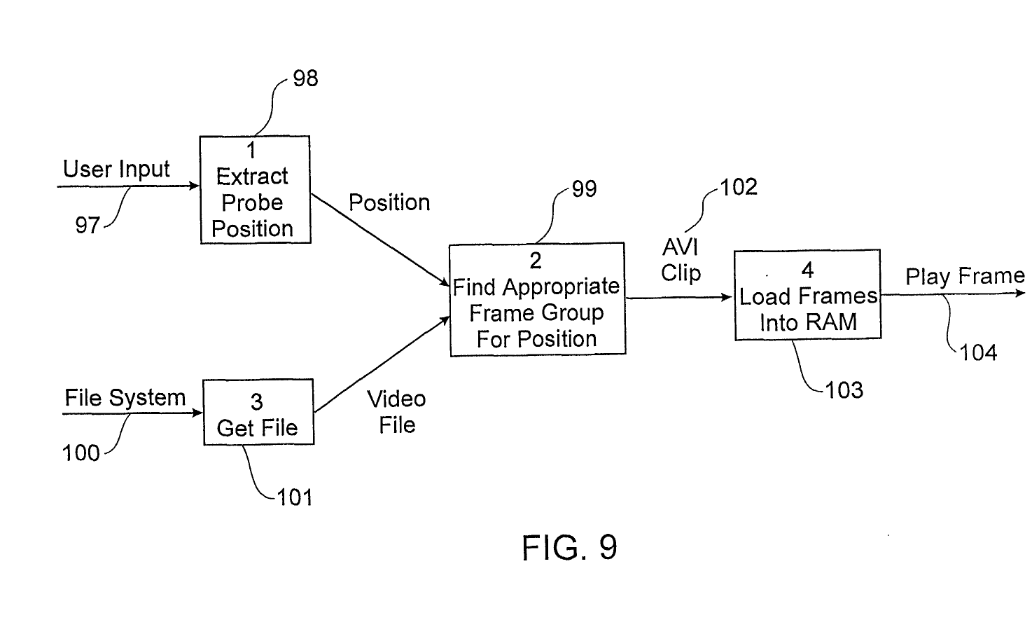

In FIG. 9, a user manipulates a probe 97, and an exact probe position is determined 98. The location is used to find an appropriate frame group for that location 99 at which time a file system 100 is accessed and relevant file retrieved 101. An audio visual clip 102 is then loaded into ram 103 of a computer and the segment is played 104.

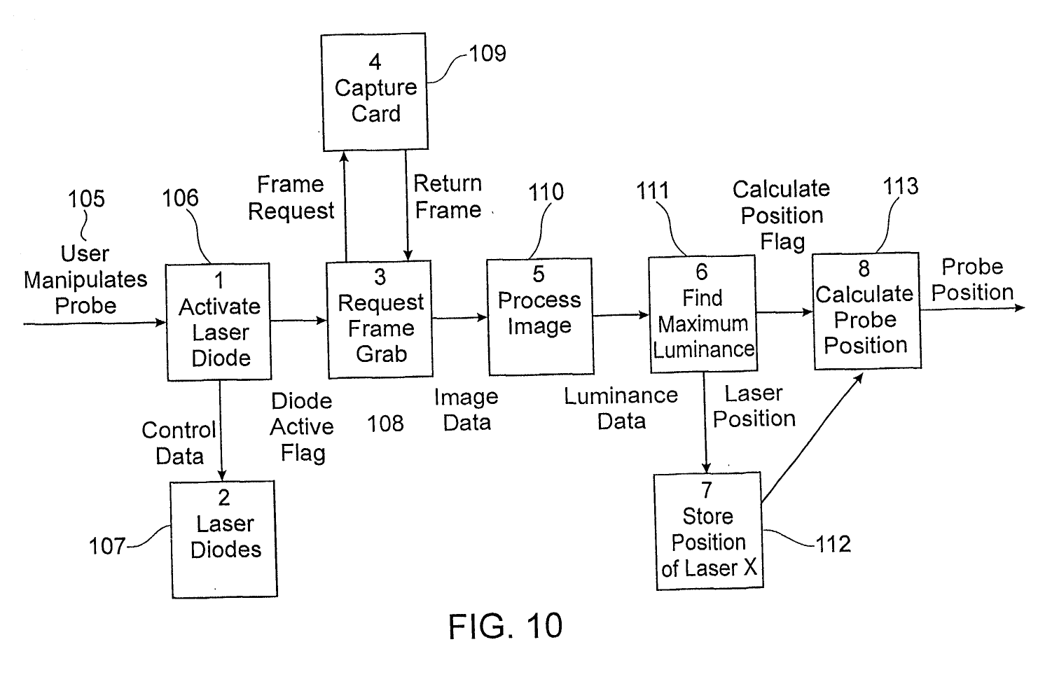

Referring to FIG. 10, a user manipulates a probe 105 which activates a laser diode 106 which is under central control as are the other laser diodes 107. Activation of the laser diode causes a request to be made 108 to video capture card 109. Information from the capture card 109 is fed back as image data which, in turn, is processed 110. The image is processed to identify the position of maximum luminescence 111 which identifies the position of a laser beam on a reference surface. This allows the positioning of that particular beam to be stored at 112 and in combination with other information concerning the other beams, location of the probe is calculated 113 to provide the actual position in three dimensions of that probe. This procedure is exploded step 98 of FIG. 9.

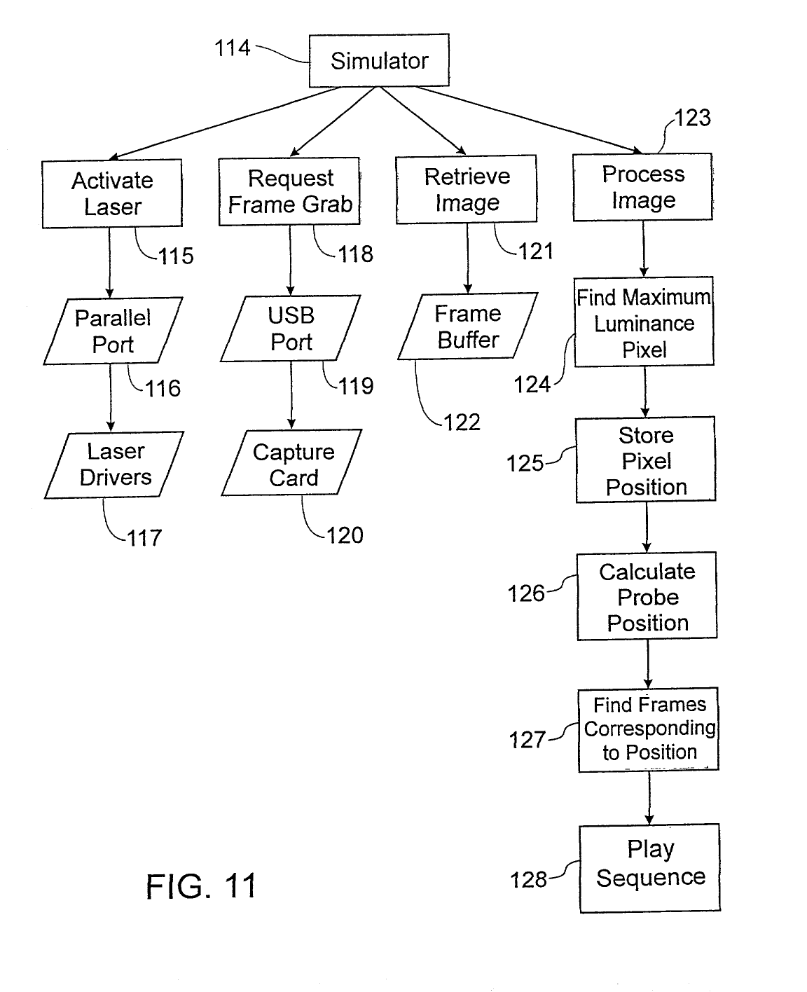

Referring to FIG. 11, there is represented an expanded flow chart of the operation of a simulator 114 in which a laser is activated 115 via the parallel port 116 of a computer which powers laser drivers 117. On activation of the laser, a request is made for a frame grab from the detector 118 via a USB port 119 of a computer in connection with the capture card 120. The image is retrieved from the camera and PCTV capture card 121 and subjected to frame buffer 122. The image is processed 123 to provide the position of maximum luminance pixel 124 which identifies the central point of the beam. The pixel position 125 is stored and combined with location information of the other beams to calculate probe location. The position of all three lasers gives the probe location and subsequent image address. Frames corresponding to that location are identified 127 and the video sequence is played 128.

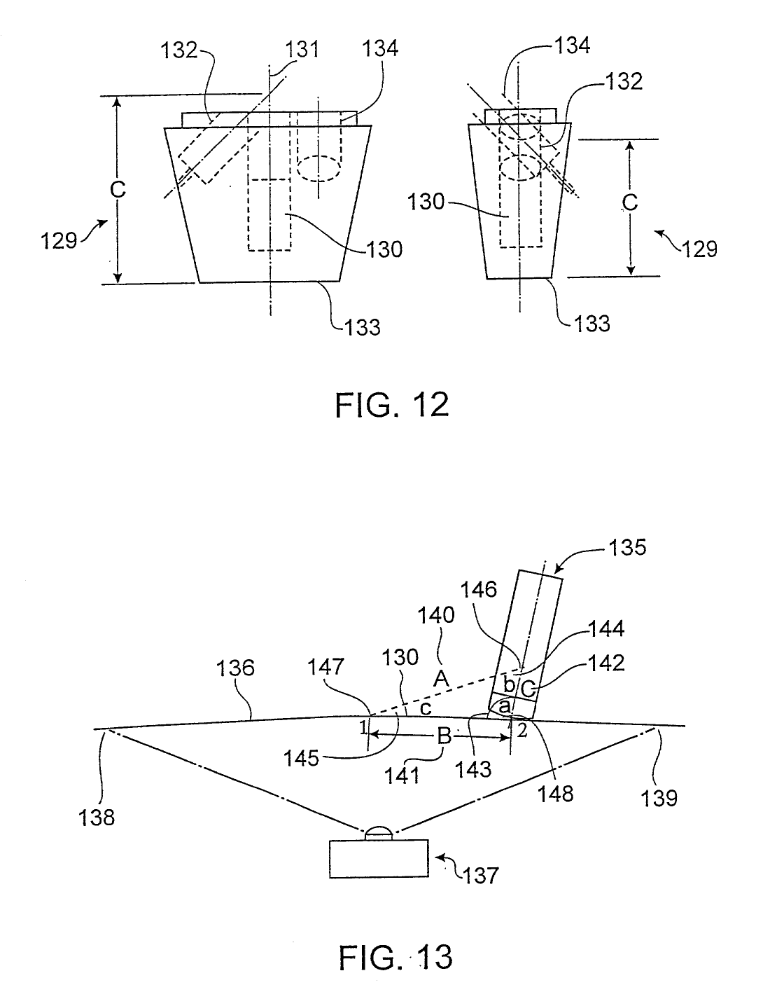

A method of calculating the position of the hand piece will now be described. FIG. 12 shows a front view and side view of a preferred embodiment of a head 129 of the hand piece or probe in which three laser sources are shown in outline. A first laser source 130 is aligned along a central longitudinal axis 131 of the head 129.

A second laser source 132 is spaced from an end 133 of the head and is offset from the longitudinal axis 131. A third laser source 134 is also spaced from the end 133 and from the longitudinal axis 131. Preferably, the axes of second laser source 132 and third laser source 134 are orthogonal to each other.

FIG. 13 is a schematic view of the simulator in use and showing a means of calculating probe inclination. The same procedure is used to calculate lateral inclination and inferior superior inclination. The probe 135 is located on mannequin surface 136. Each laser is activated individually and the position of incidence of the laser beam on the surface of the mannequin 136 is detected and recorded. The difference of X and Y co-ordinates on the surface 136 between the centre laser beam and another laser beam is calculated in pixels and converted to millimeters. This is done by measuring the capture arc of the camera 137 (between points 138 and 139) and dividing that by the pixel resolution in that plane. It is now possible to represent a triangle consisting of sides: (A) 140; (B) 141; and (C) 142; and angles: (a) 143; (b) 144; and (c) 145. The length of (C) 142 is known as the distance between the tip of the probe 135 and the point 146 where the longitudinal axis of the other laser crosses the longitudinal axis of the probe. The dimension of side (B) 141 is the distance between the incidence of the other laser beam as represented by side (A) hitting the surface 136 at point 147 and the position of the centre laser at 148. Angle (b) 144 is always known as it is the constant angle between the longitudinal axis of the other laser beam under consideration and longitudinal axis of the probe 135. It is now possible to use the sine rule which is:

$$\frac{A}{sin α} = \frac{B}{sin b} = \frac{C}{sin c}$$

It is possible to find angle (a), which is the tilt of the probe by first finding (c) using the formula:

$${sin}^{- 1} ( C / ( \frac{B}{sin b} ) ) = c$$

As the sum of the angles in the triangle is 180°, once angle (c) is calculated, angle (a) can be calculated by:

aα180−(b+c)

The same process is used to find the inclination in a direction at 90° to the first identified angle of inclination, thereby giving a three dimensional position for the probe.

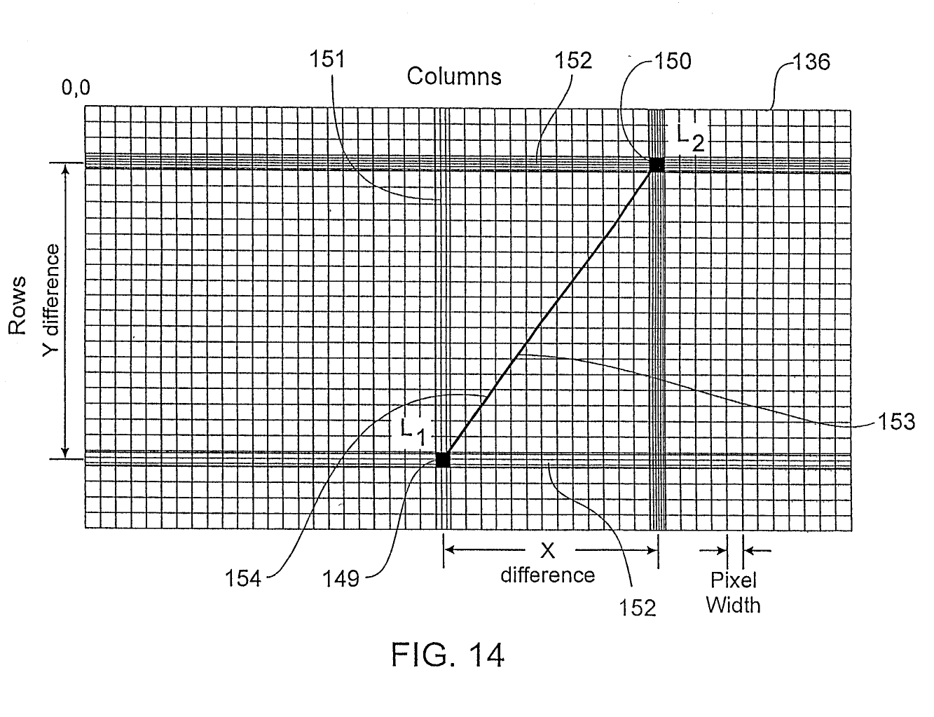

FIG. 14 shows a representation of the reference surface 136 when considered for a method for calculating rotations. The beam of central laser 130 strikes the surface 136 at point 149, which is the position of incidence of the centre beam. This is classified as the X co-ordinate of the centre laser beam, which becomes the vertical reference column for calculation for rotation angle. The position of incidence 150 of another laser beam is also calculated and both positions are given X and Y co-ordinates based on the division of the mannequin reference surface 136 into pixels. The X and Y co-ordinate differences between the centre and other laser beam points of incidence are then calculated and a triangle is formed with sides 151 (side Y), 152 (side X), 153. Rotation angle 154 is given the notional indicator of c and is calculated by the equation:

$$tan c = ( \frac{X}{Y} )$$

therefore angle:

$$c = {tan}^{- 1} ( \frac{X}{Y} )$$

thus giving the angle of rotation.

As a result of the invention, it is possible to produce a realistic training simulator that has particular economic advantages in avoiding the requirement for use of expensive diagnostic machines. Additionally, a trainee may practice in their own time without requiring the expensive presence of an overseer to ensure that the machine is being used properly and that no risk is presented to a patient or subject. The simulator of the invention may be constructed as highly portable device. It also may be constructed at a relatively low cost using commonly available components. The simulator may be highly realistic which is an important part of the value of any such device. When the probe is positioned correctly, a simulator according to the present invention may realistically present on screen all the major cardiac structures normally visible in that particular plane of view during diagnostic imaging.

Throughout the specification, the aim has been to describe the preferred embodiments of the invention without limiting the invention to any one embodiment or specific collection of features. Various changes and modifications may be made to the embodiments described and illustrated without departing from the present invention.

The claims defining the invention are as follows:

1. A diagnostic imaging simulator comprising:
a mobile hand piece for emitting at least three spaced beams;
a reference surface;
a detector for detecting the positions of the at least three beams on the reference surface;
a location determining device for determining the location of the mobile hand piece relative to the reference surface using the incidence of the at least three beams on the reference surface; and
a display for displaying an image associated with the location of the mobile hand piece.

2. The diagnostic imaging simulator of claim 1, wherein the mobile hand piece is elongate with a central longitudinal axis.

3. The diagnostic imaging simulator of claim 1, wherein the mobile hand piece has a contact region for contacting the reference surface.

4. The diagnostic imaging simulator of claim 1, wherein the mobile hand piece comprises at least three spaced beam sources.

5. The diagnostic imaging simulator of claim 4, wherein at least two of the spaced beam sources are located in positions removed from the contact region of the hand piece.

6. The diagnostic imaging simulator of claim 4, wherein one of the beam sources is sited in the mobile hand piece to produce a beam along a central longitudinal axis of the mobile hand piece.

7. The diagnostic imaging simulator of claim 4, wherein the at least three spaced beam sources are laser diodes.

8. The diagnostic imaging simulator of claim 7, wherein each laser diode is an infrared laser diode.

9. The diagnostic imaging simulator of claim 4, wherein the at least three spaced beam sources are orientated to produce divergent beams.

10. The diagnostic imaging simulator of claim 4, wherein the at least three spaced beam sources are orientated to produce parallel beams.

11. The diagnostic imaging simulator of claim 4, wherein the at least three spaced beam sources are orientated to produce convergent beams.

12. The diagnostic imaging simulator of claim 1 comprising four spaced beam sources.

13. The diagnostic imaging simulator of claim 12, wherein one of the four spaced beam sources is orientated to produce a central beam relative to the other beams.

14. The diagnostic imaging simulator of claim 1, wherein the reference surface is located intermediate the mobile hand piece and the detector.

15. The diagnostic imaging simulator of claim 1, wherein the reference surface transmits the at least three spaced beams.

16. The diagnostic imaging simulator of claim 1, wherein the reference surface is a model of an anatomical region.

17. The diagnostic imaging simulator of claim 16, wherein the anatomical region is at least the thorax of a person.

18. The diagnostic imaging simulator of claim 1, wherein the detector is a camera.

19. The diagnostic imaging simulator of claim 18, wherein the camera is a charge-coupled device (“CCD”) camera.

20. The diagnostic imaging simulator of claim 1, wherein the location determining device comprises a processor in signal connection with the detector, the location determining device programmed to determine the location of the mobile hand piece.

21. The diagnostic imaging simulator of claim 1, wherein the location determining device is programmed to determine the location by establishing position, rotation and angle of inclination of the mobile hand piece relative to the reference surface.

22. The diagnostic imaging simulator of claim 20, wherein the processor is a computer.

23. The diagnostic imaging simulator of claim 22, wherein the location determining device is programmed to determine the location of the mobile hand piece in two dimensions.

24. The diagnostic imaging simulator of claim 22, wherein the location determining device is programmed to determine the location of the mobile hand piece in three dimensions.

25. The diagnostic imaging simulator of claim 1, wherein the display is a video display unit.

26. The diagnostic imaging simulator of claim 1, wherein the image is a video sequence.

27. The diagnostic imaging simulator of claim 1, wherein the image is an image of an anatomical structure.

28. The diagnostic imaging simulator of claim 1, further comprising a library of stored video images, each video image associated with a respective location of the mobile hand piece.

29. The diagnostic imaging simulator of claim 28, wherein the video images are three dimensional computer generated models.

30. The diagnostic imaging simulator of claim 1, further comprising a beam identifier for identifying each beam.

31. The diagnostic imaging simulator of claim 30, wherein the beam identifier comprises a controller to control emission of the beams.

32. The diagnostic imaging simulator of claim 31, wherein the controller comprises a sequential activator for emitting the beams sequentially.

33. A method of simulating a diagnostic imaging apparatus including the steps of:
transmitting at least three spaced beams from individual sources on a mobile hand piece;
detecting the relative positions of the spaced beams on a reference surface spaced from at least two of the sources;
determining the location of the mobile hand piece from the relative position of the at least three beams; and
displaying an image associated with the position of the mobile hand piece.

34. The method of claim 33, further including the step of transmitting a fourth beam.

35. The method of claim 33, further including the step of identifying individual beams.

36. The method of claim 35, wherein the step of identifying individual beams includes the step of transmitting the beams sequentially.

37. A method of simulating a diagnostic imaging apparatus including the steps of:
placing a mobile hand piece on a model of an anatomical surface;
transmitting at least three laser beams from the mobile hand piece;
detecting the relative position of the three laser beams with a camera spaced from the model;
determining the location of the mobile hand piece from the relative position of the laser beams; and
displaying a video image of an anatomical structure associated with the position of the mobile hand piece.

38. The method of claim 37, wherein the step of determining the location of the mobile hand piece further comprises the step of calculating inclination of the mobile hand piece using the equation:
$${sin}^{- 1} ( C / ( \frac{B}{sin b} ) ) = c$$
where:
B is a distance between the point of incidence of one of the laser beams on the anatomical surface and a point on the anatomical surface that coincides with a central longitudinal axis of the mobile hand piece;
b is an angle between the one of the laser beams and the central longitudinal axis of the mobile hand piece;
C is a distance between a tip of the mobile hand piece and a point at which a longitudinal axis of the one of the laser beams crosses the central longitudinal axis of the mobile hand piece; and
c is an angle between the one of the laser beams and the anatomical surface.

39. The method of claim 38, further including calculating an angle a using the equation:
aα180−(b+c)
where a is an angle between the central longitudinal axis of the mobile hand piece and the anatomical surface.

40. The method of claim 37, wherein the step of determining the location of the mobile hand piece further comprises the step of calculating rotation angle c of the mobile hand piece using the equation:
$$c = {tan}^{- 1} ( \frac{X}{Y} )$$
where X and Y are coordinate differences between points of incidence on the anatomical surface of a laser beam from a central laser and a laser beam from another laser.
